(19) United States
(12) Patent Application Publication
(10) Pub. No.: US 2013/0322519 A1
(43) Pub. Date: Dec. 5, 2013

(54) VIDEO PROCESSING METHOD USING ADAPTIVE WEIGHTED PREDICTION

(71) Applicant: CORE LOGIC INC., Seoul (JP)

(72) Inventor: JIHO CHOI, Seoul (KR)

(73) Assignee: CORE LOGIC INC., Seoul (JP)

(21) Appl. No.: 13/899,923

(22) Filed: May 22, 2013

(30) Foreign Application Priority Data
May 29, 2012 (KR) 10-2012-0056550

(51) Int. Cl. H04N 7/26

(52) U.S. Cl. CPC H04N 19/00139
USPC 375/240.02

(57) ABSTRACT

The present disclosure provides a video processing method using adaptive weighted prediction. The video processing method includes dividing a reference frame into a plurality of reference divisional areas, dividing a current frame into a plurality of current divisional areas, calculating absolute values of differences between respective average brightness values of the plural reference divisional areas and respective average brightness values of the plural current divisional areas, calculating a standard deviation of the absolute values, and implementing adaptive weighted prediction with regard to the current frame when the standard deviation exceeds a predetermined critical value. Thus, the video processing method can more quickly process rapid variation in brightness of an image with less operation when the rapid variation in brightness occurs due to flash, fade-in, fade-out, etc.

### CROSS-REFERENCE TO RELATED APPLICATION

This application claims priority to Korean Patent Application No. 10-2012-0056550 filed on 29 May, 2012, and all the benefits accruing therefrom under 35 U.S.C. §119, the contents of which is incorporated by reference in its entirety.

### BACKGROUND

1. Technical Field

The present invention relates to a video processing method, and more particularly, to a video processing method using adaptive weighted prediction.

2. Description of the Related Art

In general, weighted prediction of H.264/AVC is a technique introduced at a level higher than a main profile so as to be adaptive to variation in brightness within an image. With the introduction of this technique, performance of peak signal to noise ratio (PSNR) is improved by 1˜2% with respect to a bit ratio when the brightness between frames is amplified or attenuated. If brightness is locally changed within an image, the performance of weighted prediction can be greatly lowered. In addition, if the brightness between frames is very rapidly and locally varied, weighted prediction provided in the existing H.264 standard may have an adverse effect on encoding in an area where there is no variation in brightness. To solve such a problem, there has been proposed a localized weighted prediction to adapt to a local brightness effect between images. Localized weighted prediction is very efficiently adaptive to local variation in brightness as in the existing weighted prediction which adapts to the whole variation in brightness.

FIG. 1 is a flowchart of a localized weighted prediction method in the related art.

First, it is determined whether a current frame needs a weighted prediction operation (102). If the weighted prediction operation is not needed, motion estimation is performed (112). If the weighted prediction operation is needed, a localized weighted prediction table is generated (104). Then, the generated table is used to determine whether the localized weighted prediction operation is needed (106). If the localized weighted prediction operation is not needed, the whole area weighted prediction operation (108) and the motion estimation (112) are performed. On the other hand, if the localized weighted prediction operation is needed, the localized weighted prediction operation is performed (110) and the motion estimation is performed (112).

As such, the localized weighted prediction technique is computationally intensive. Although the localized weighted prediction is used to effectively respond to local variation in brightness, it is unusual that all frames of one image are locally and very rapidly varied in brightness.

Therefore, there is a need for a weighted prediction technique that more quickly operates and requires less operation when brightness is remarkably varied between corresponding frames.

### BRIEF SUMMARY

One aspect of the present invention is to provide a video processing method, which can more quickly process rapid variation in brightness of an image with less operation when the rapid variation in brightness occurs due to flash, fade-in, fade-out, etc.

In accordance with one aspect of the present invention, a video processing method includes: dividing a reference frame into a plurality of reference divisional areas; dividing a current frame into a plurality of current divisional areas; calculating absolute values of differences between respective average brightness values of the plural reference divisional areas and respective average brightness values of the plural current divisional areas; calculating a standard deviation of the absolute values; and implementing adaptive weighted prediction with regard to the current frame if the standard deviation exceeds a predetermined critical value.

In accordance with another aspect of the present invention, a video processing method includes: dividing a reference frame into a plurality of reference divisional areas; dividing a current frame into a plurality of current divisional areas; selecting a current divisional area exhibiting the largest variation in brightness with regard to the plural reference divisional areas among the plural current divisional areas; and implementing adaptive weighted prediction with regard to the selected current divisional area.

The present invention is not limited to the above aspect, and other aspects, objects, features and advantages of the present invention will be understood from the detailed description of the following embodiments of the present invention. In addition, it will be readily understood that the aspects, objects, features and advantages of the present invention can be achieved by the accompanied claims and equivalents thereof.

### BRIEF DESCRIPTION OF THE DRAWINGS

The above and other aspects, features, and advantages of the present invention will become apparent from the detailed description of the following embodiments in conjunction with the accompanying drawings, in which:

FIG. 1 is a flowchart of a localized weighted prediction method in the related art;

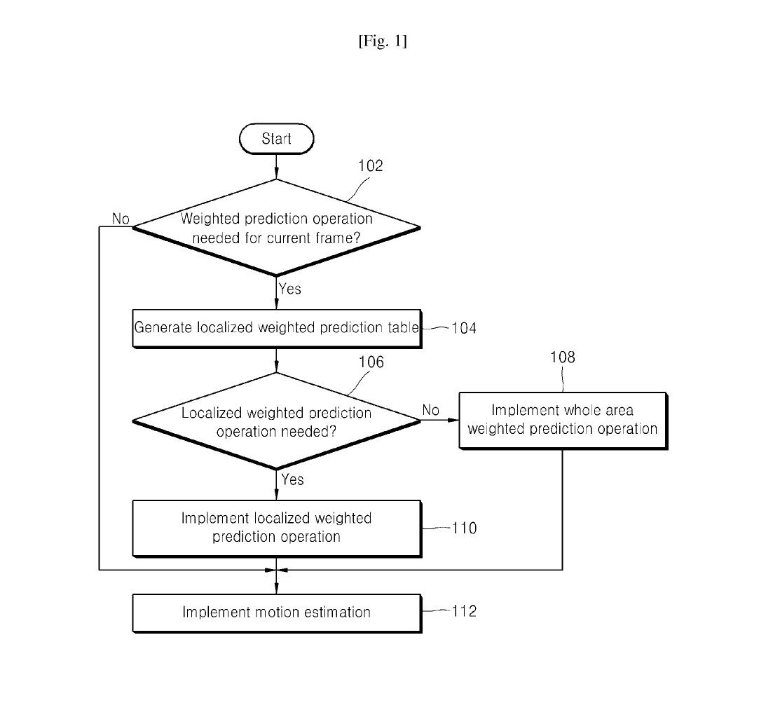

FIG. 2 is a flowchart of a video processing method according to one embodiment of the present invention;

FIG. 3 is a view explaining an adaptive weighted prediction table used in the video processing method according to one embodiment of the present invention;

FIG. 4 is a flowchart of an adaptive weighted prediction operation implemented in the video processing method according to one embodiment of the present invention;

FIG. 5 is a view explaining an area for adaptive weighted coefficient application performed in the video processing method according to one embodiment of the present invention;

FIG. 6 is a flowchart of a video processing method according to another embodiment of the present invention; and

FIG. 7 is a flowchart of a video processing method according to a further embodiment of the present invention.

### DETAILED DESCRIPTION

Exemplary embodiments of the present invention will now be described in detail with reference to the accompanying drawings. It should be understood that the present invention is not limited to the following embodiments and may be embodied in different ways, and that the embodiments are given to provide complete disclosure of the invention and to provide thorough understanding of the invention to those skilled in the art. Descriptions of details apparent to those skilled in the art will be omitted for clarity of description. The same components will be denoted by the same reference numerals throughout the specification.

First, a video processing method according to one embodiment of the present invention will be described.

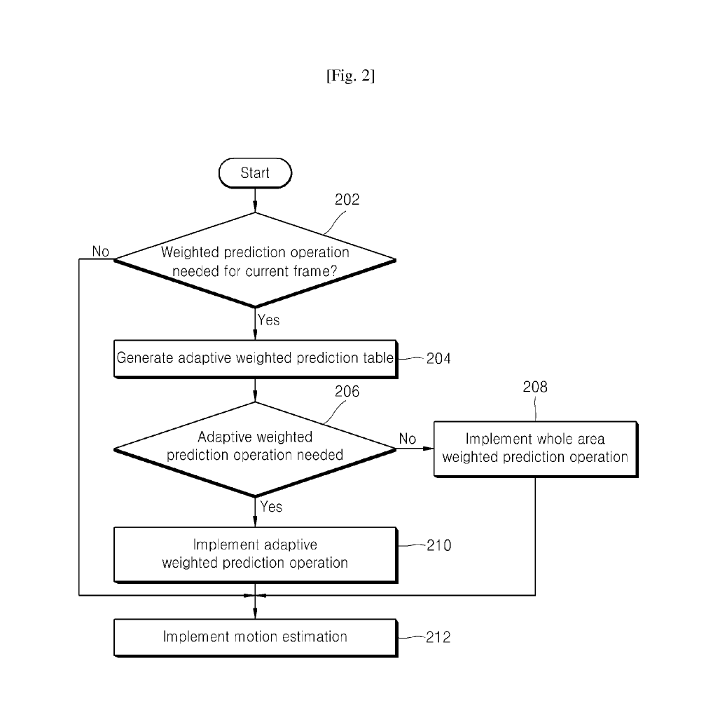

FIG. 2 is a flowchart of a video processing method according to one embodiment of the present invention.

Referring to FIG. 2, it is first determined whether a current frame requires a weighted prediction operation (202). To this end, in this embodiment, difference between an average brightness value of all whole pixels in a reference frame and an average brightness value of all pixels in a current frame is calculated, and the calculated difference in the average value is compared with a preset critical value. This operation is to determine how much the brightness of the current frame is varied from the brightness of the reference frame.

As a result of the determination (202), if the difference between the average brightness value of all pixels in the reference frame and the average brightness value of all pixels in the current frame is smaller than the critical value, it is determined that the weighted prediction operation of the current frame is not needed, and motion estimation is performed (212).

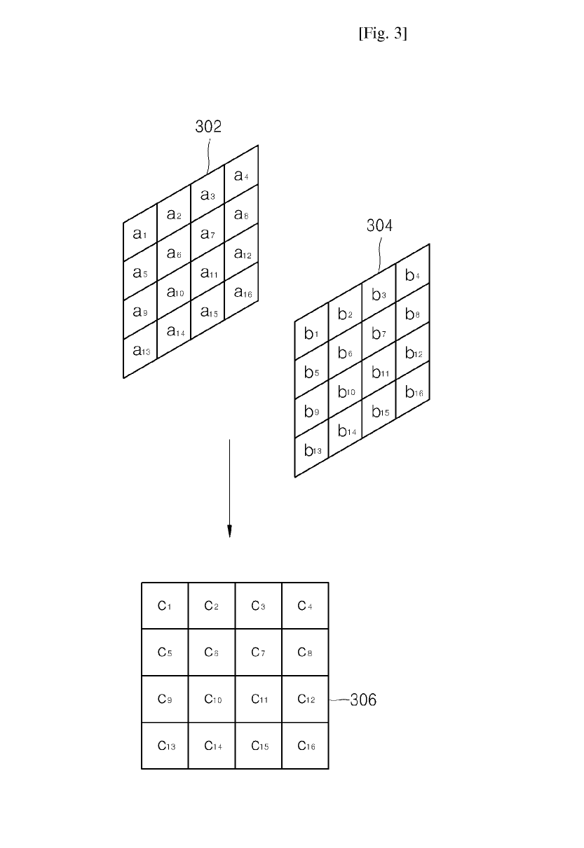

As a result of the determination (202), if the difference between the average brightness value of all pixels in the reference frame and the average brightness value of all pixels in the current frame exceeds the critical value, it is determined that the weighted prediction operation of the current frame is needed. Thus, in the next operation, an adaptive weighted prediction table is generated (204). The adaptive weighted prediction table will be described with reference to FIG. 3.

FIG. 3 is a view explaining an adaptive weighted prediction table used in the video processing method according to one embodiment of the present invention. In FIG. 3, the reference frame 302 and the current frame 304 are used to generate the adaptive weighted prediction table 306. First, the reference frame 302 and the current frame 304 are divided into divisional areas corresponding to a preset number. Although each frame is illustrated as being divided into sixteen divisional areas in FIG. 3, it should be understood that the present invention is not limited thereto.

Next, the average brightness value of the pixels included in each divisional area is calculated. In FIG. 3, the average brightness values of the divisional areas of the reference frame 302 are represented by a1˜a16, respectively, and the average brightness values of the divisional areas of the current frame 304 are represented by b1˜b16, respectively.

Such a calculated average brightness value corresponding to each divisional area is used to generate the adaptive weighted prediction table 306. The adaptive weighted prediction table 306 is generated by calculating an absolute value between the average brightness value of each divisional area of the reference frame 302 and the average brightness value of each divisional area of the current frame 304. For example, in the adaptive weighted prediction table 306 of FIG. 3, cl is calculated by Expression 1:

c1=|a1−b1|.

Referring again to FIG. 2, the adaptive weighted prediction table 306 completed as shown in FIG. 3 is used to determine whether the adaptive weighted prediction operation is needed (206). In one embodiment, a standard deviation of c1˜c16 in the adaptive weighted prediction table 306 is calculated by Expression 2:

\sqrt{E(c²)−E(c)²}.

In Expression 2, E(c) is an average value of c in the adaptive weighted prediction table 306, and E(c²) is an average value of the square of c. As a result, Expression 2 shows the standard deviation of c in the adaptive weighted prediction table 306.

Using the calculated standard deviation, it is determined whether the adaptive weighted prediction operation is needed (206). If the calculated standard deviation is smaller than the preset critical value, it is determined that the adaptive weighted prediction operation is not needed, and thus the whole area weighted prediction operation (208) and the motion estimation (212) are implemented in sequence. Here, the whole area weighted prediction operation (208) provides a weighted value by a darkened degree or brightened degree to increase similarity between images, thereby enhancing inter-coding efficiency.

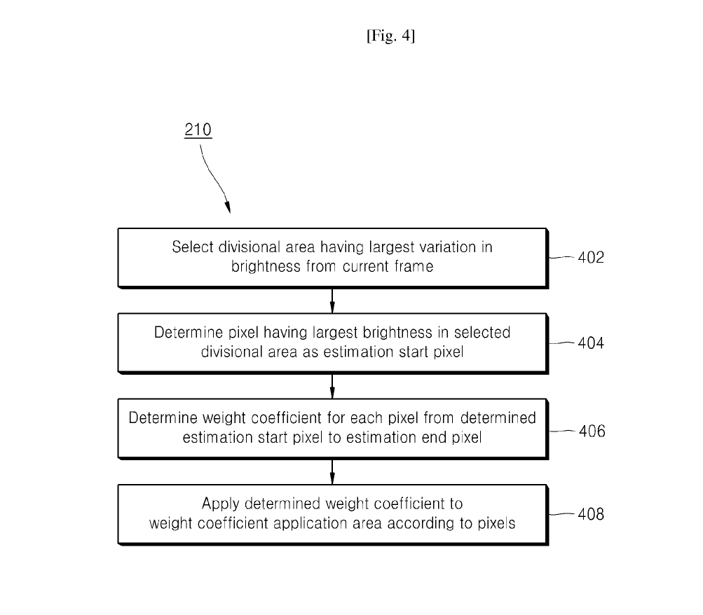

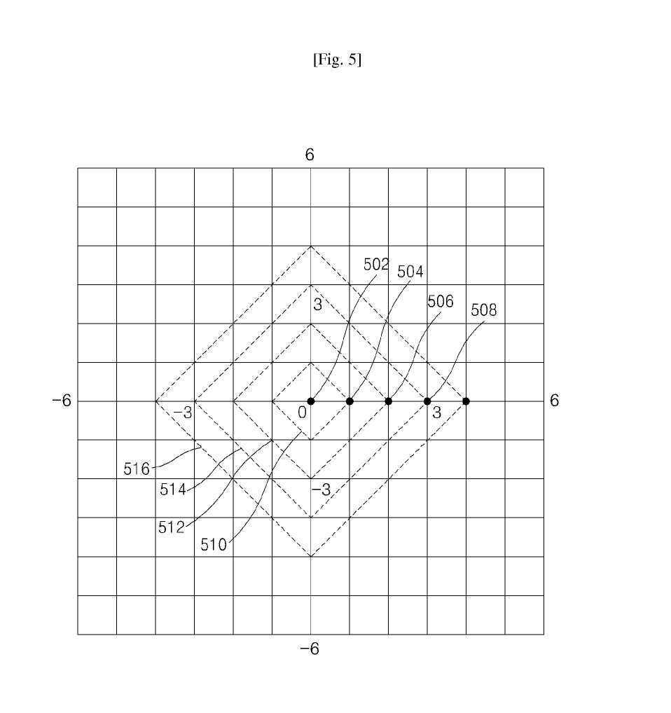

If the calculated standard deviation exceeds the preset critical value, it is determined that the adaptive weighted prediction operation is needed. Thus, the adaptive weighted prediction operation is implemented with regard to the current frame (210). The adaptive weighted prediction operation (210) will be described with reference to FIGS. 4 and 5.

FIG. 4 is a flowchart of an adaptive weighted prediction operation implemented in the video processing method according to one embodiment of the present invention, and FIG. 5 is a view for explaining an area of an adaptive weighted coefficient application performed in the video processing method according to one embodiment of the present invention.

In one embodiment of the present invention, the adaptive weighted prediction operation (210) is performed as follows. First, a divisional area exhibiting the largest variation in brightness is selected in the current frame (402). The divisional area exhibiting the largest variation in brightness refers to an area of the current frame corresponding to an area having the largest value in the adaptive weighted prediction table 306 generated as above. This is because the adaptive weighted prediction table 306 shows the absolute value of the difference in brightness between the current frame and the reference frame. For example, if c12 has the largest value among c1˜c16 in the adaptive weighted prediction table 306 of FIG. 3, an area a12 is selected in operation 402 of FIG. 4.

FIG. 5 is a view showing coordinates for pixels in the selected divisional area. For reference, the coordinates of FIG. 5 refer to one pixel included in the corresponding divisional area.

Then, the pixel having the largest brightness level in the divisional area of the selected current frame is determined as an estimation start pixel (404). In FIG. 5, coordinates 502 at (0,0) indicate the estimation start pixel.

Next, a weight coefficient for each pixel is determined from the determined estimation start pixel to an estimation end pixel (406). Here, the weight coefficient is defined as a quotient when a brightness value of one pixel is divided by a brightness value of the next pixel. For example, the weight coefficient of the pixel 502 is a quotient obtained by dividing the brightness value of the pixel 502 by the brightness value of the pixel 504.

Here, the estimation end pixel may be determined in various ways in accordance with embodiments. For example, the weight coefficient may be determined from the estimation start pixel up to a pixel corresponding to a preset number (d). In this case, the estimation end pixel is determined at a position separated a distance (d) from the estimation start pixel.

Further, in another embodiment, if the weight value of each pixel is within a preset range, the corresponding pixel may be determined as the estimation end pixel. For example, if the weight coefficient of the pixel 508 in FIG. 5 is within a preset range, for example, between 0.09 and 1.09, the pixel 508 is determined as the estimation end pixel and the adaptive weighted prediction operation is finished at the pixel 508.

The adaptive weighted prediction operation may be sequentially performed in an arbitrary direction. For example, in another embodiment, the adaptive weighted prediction operation may be performed in a direction of (0,−1), (0,−2), (0,−3), . . . with respect to the estimation start pixel 502 of FIG. 5.

Finally, the determined weight coefficient is applied to the weight coefficient application area according to pixels (408). In this embodiment, the weight coefficient application area according to the pixels is defined as an area including pixels located on a line forming a lozenge shape, in which the estimation start pixel is placed at the center and a diagonal line is twice a distance from the estimation start pixel to each pixel. For example, in FIG. 5, the weight coefficient application area of the pixel 506 includes all coordinates on the line forming a geometrical FIG. 512. For reference, since such a lozenge shape is also shaped like a diamond, the adaptive weighted prediction operation of the present invention may be named “diamond search”. The weight coefficient of the pixel 506 is applied to all coordinates (pixels) included in the weight coefficient application area. Similarly, the weight coefficient of the pixel 508 may be applied to all coordinates on a line forming the geometrical FIG. 514.

If the determined weight coefficient is applied to the weight coefficient application area according to the pixels (408), the adaptive weighted prediction operation mentioned in operation 210 of FIG. 2 is finished. Then, motion estimation is performed with regard to the corresponding frame (212).

In the embodiment described with reference to FIG. 2, the brightness value of each pixel is used to implement the adaptive weighted prediction operation. However, the present invention may use another value representing “brightness” of the corresponding frame. For example, in another embodiment, pixel contrast may be used instead of the pixel brightness. In the above embodiment, the higher the brightness or average value of the frame, the brighter the corresponding frame or pixel. However, in this embodiment, the lower the contrast, the brighter the corresponding frame or pixel. As a result, those skilled in the art can modify and achieve the foregoing embodiment based upon contrast or other values representing brightness of the pixel.

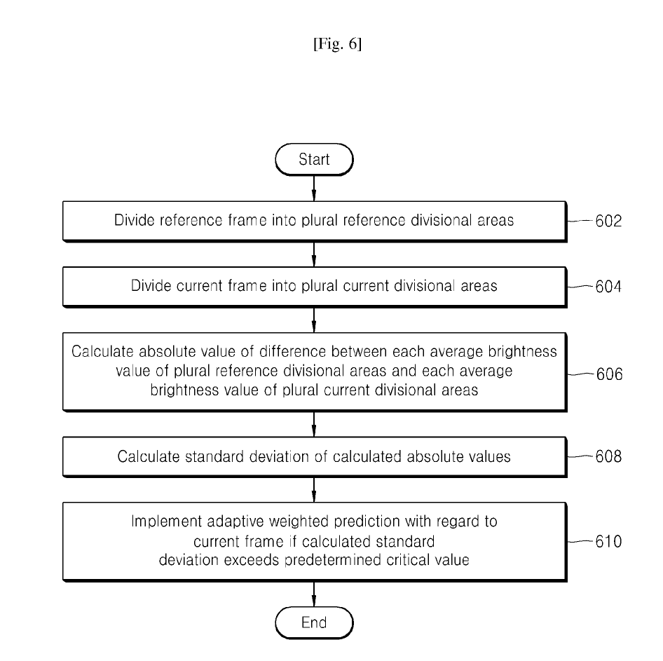

FIG. 6 is a flowchart of a video processing method according to another embodiment of the present invention.

First, a reference frame is divided into a plurality of reference divisional areas (602), and a current frame is divided into a plurality of current divisional areas (604). Then, an absolute value of difference between each average brightness value of the plural reference divisional areas and each average brightness value of the plural current divisional areas is calculated (606). Such an absolute value of the difference indicates a degree of variation in brightness between the current frame and the reference frame with regard to the same area or pixel.

Next, a standard deviation of the absolute values calculated by operation 606 is calculated (608). The standard deviation indicates brightness distribution in each area. The difference in brightness between the areas increases with increasing standard deviation.

Finally, if the calculated standard deviation exceeds a predetermined critical value, adaptive weighted prediction is implemented with regard to the current frame (610). Here, operation of implementing adaptive weighted prediction may include selecting a current divisional area having the largest absolute value among the absolute values of the differences in brightness between the respective average brightness values of the plural reference divisional areas and the respective average brightness values of the plural current divisional areas; determining an estimation start pixel in the selected current divisional area, determining a weight coefficient of each pixel from the estimation start pixel to the estimation end pixel; and applying the weight coefficient to the weight coefficient application area according to the respective pixels. Here, the estimation start pixel may be a pixel having the largest brightness value in the selected current divisional area. Also, the estimation end pixel may be a pixel having a weight coefficient within a preset range. The weight coefficient application area according to pixels is defined as an area including the pixels located on a line forming a lozenge shape in which the estimation start pixel is placed at the center and a diagonal line is twice a distance from the estimation start pixel to each pixel.

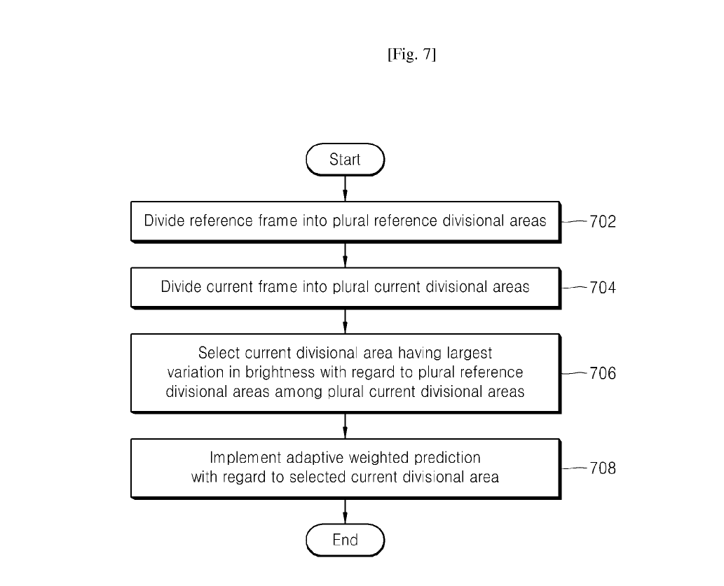

FIG. 7 is a flowchart of a video processing method according to a further embodiment of the present invention.

First, a reference frame is divided into a plurality of reference divisional areas (702), and a current frame is divided into a plurality of current divisional areas (704). Then, a current divisional area exhibiting the largest variation in brightness with regard to the plural reference divisional areas is selected among the plural current divisional areas (706). This operation is performed for selective implementation of weighted prediction with regard to only the divisional area exhibiting the largest variation in brightness. Here, operation 706 of selecting the current divisional area may include selecting the current divisional area having the largest absolute value among absolute values of the differences between respective average brightness values of the plural reference divisional areas and respective average brightness values of the plural current divisional areas.

Next, adaptive weighted prediction is implemented with regard to the selected current divisional area (708). Here, operation 708 of implementing adaptive weighted prediction may include determining an estimation start pixel in the selected current divisional area; determining a weight coefficient of each pixel from the estimation start pixel to an estimation end pixel; and applying the weight coefficient to the weight coefficient application area according to the respective pixels.

Further, the estimation start pixel may be a pixel having the largest brightness in the selected current divisional area. Also, the estimation end pixel may be a pixel having the weight coefficient within a preset range. Meanwhile, the weight coefficient application area according to pixels is defined as an area including the pixels located on a line forming a lozenge shape in which the estimation start pixel is placed at the center and a diagonal line is twice a distance from the estimation start pixel to each pixel.

As such, advantageously, the video processing method according to the present invention can more quickly process rapid variation in brightness of an image with less operation when the rapid variation in brightness occurs due to flash, fade-in, fade-out, etc.

Although some exemplary embodiments have been described herein, it should be understood by those skilled in the art that these embodiments are given by way of illustration only, and that various modifications, variations and alterations can be made without departing from the spirit and scope of the invention. The scope of the present invention should be defined by the appended claims and equivalents thereof.

What is claimed is:

1. A video processing method comprising:
dividing a reference frame into a plurality of reference divisional areas;
dividing a current frame into a plurality of current divisional areas;
calculating absolute values of differences between respective average brightness values of the plural reference divisional areas and respective average brightness values of the plural current divisional areas;
calculating a standard deviation of the absolute values; and
implementing adaptive weighted prediction with regard to the current frame when the standard deviation exceeds a predetermined critical value.

2. The video processing method according to claim 1, wherein the implementing adaptive weighted prediction comprises:
selecting a current divisional area having the largest absolute value among the absolute values of differences between the respective average brightness values of the plural reference divisional area and the respective average brightness values of the plural current divisional areas;
determining an estimation start pixel in the selected current divisional area;
determining a weight coefficient of each pixel from the estimation start pixel to an estimation end pixel; and
applying the weight coefficient to a weight coefficient application area according to the respective pixels.

3. The video processing method according to claim 2, wherein the estimation start pixel comprises a pixel having the largest brightness value in the selected current divisional area.

4. The video processing method according to claim 2, wherein the estimation end pixel comprises a pixel having the weight coefficient within a preset range.

5. The video processing method according to claim 2, wherein the weight coefficient application area according to the respective pixels comprises pixels located on a line forming a lozenge shape in which the estimation start pixel is placed at a center thereof and a diagonal line is twice a distance from the estimation start pixel to each pixel.

6. A video processing method comprising:
dividing a reference frame into a plurality of reference divisional areas;
dividing a current frame into a plurality of current divisional areas;
selecting a current divisional area exhibiting the largest variation in brightness with regard to the plural reference divisional areas among the plural current divisional areas; and
implementing adaptive weighted prediction with regard to the selected current divisional area.

7. The video processing method according to claim 6, wherein the selecting the current divisional area comprises:
selecting the current divisional area having the largest absolute value among the absolute values of differences between respective average brightness values of the plural reference divisional areas and respective average brightness values of the plural current divisional areas.

8. The video processing method according to claim 6, wherein the implementing the adaptive weighted prediction comprises:
determining an estimation start pixel in the selected current divisional area;
determining a weight coefficient of each pixel from the estimation start pixel to an estimation end pixel; and
applying the weight coefficient to a weight coefficient application area according to the respective pixels.

9. The video processing method according to claim 8, wherein the estimation start pixel comprises a pixel having the largest brightness value in the selected current divisional area.

10. The video processing method according to claim 8, wherein the estimation end pixel comprises a pixel having the weight coefficient within a preset range.

11. The video processing method according to claim 8, wherein the weight coefficient application area according to the respective pixels comprises pixels located on a line forming a lozenge shape in which the estimation start pixel is placed at a center thereof and a diagonal line is twice a distance from the estimation start pixel to each pixel.
